(19) United States
(12) Patent Application Publication
(10) Pub. No.: US 2006/0013415 A1
(43) Pub. Date: Jan. 19, 2006

(54) Voice activation and transmission system

(76) Inventor: Charles E. Winchester, Hamden, CT (US)

Correspondence Address: ST. ONGE STEWARD JOHNSTON & REENS, LLC, 986 BEDFORD STREET, STAMFORD, CT, 06905-5619, US

(21) Appl. No.: 10/891,571

(22) Filed: Jul. 15, 2004

(51) Int. Cl. H04R 3/00; G10L 21/00; G10K 11/00

(52) U.S. Cl. 381/110; 704/275; 367/198

(57) ABSTRACT

A portable voice-activated transmission system that may safely be used in a hazardous location, which effectively eliminates loss of audio input and reduces transmission of ambient noise through use of gathering multiple audio signal inputs from the acoustic environment, storing the gathered audio signals, conversion of the multiple audio signals to digital signals, and generation of a single output signal representative of the gathered audio signals.

### FIELD OF THE INVENTION

The invention relates generally to the field of voice-activated transmission (“VOX”) systems, and more particularly to an improved method and system for ensuring reliability of complete transmission and for noise cancellation in connection with VOX systems.

### BACKGROUND OF THE INVENTION

One form of transmission of voice in wireless communications is to have voice-activated transmission (“VOX”) where a radio transmitter opens when a human voice is recognized. These types of systems have been in use for some time. Generally, voice activation is achieved using circuitry design, such as is disclosed in U.S. Pat. No. 5,457,769 which is incorporated herein by reference.

VOX systems are designed such that the system will not transmit unless a human voice is detected. However, a problem that is common to these systems is the latency of the transmission. There is a lag time between the start time of human speech into the VOX system, and the start time of transmission once the system has identified human voice. This lag time causes the beginning of the human speech to be lost, which may have adverse effects. For instance, the adage is described as follows; the user speaks into the VOX system saying “Don't shoot” while the hearer, because of the delay in the starting of transmission, only hears “Shoot.”

A number of patents have attempted to deal with the problem of loss of data in voice-activated systems. For instance, U.S. Pat. No. 6,385,304 to Hunt et al. (“the '304 patent”) and U.S. Pat. No. 5,155,760 to Johnson et al. (“the '760 patent”) disclose a system and method for speech-responsive voice messaging. Both the '304 patent and the '760 patent disclose the use of a buffer for holding audio data to compensate for time delays in, for instance, determining whether logging is to begin. However, both of these references are directed at a voice messaging and retrieval system, not a VOX system. A VOX system presents different problems and parameters than do voice messaging systems. For instance, a VOX system is generally portable, the voice activation circuitry many times being located in the voice input device, such as a microphone or other portable device. In addition, the VOX system is a system that not only receives an input, but generates an output according to selected criteria to be transmitted to for instance, a transducer. This requires that that the voice activation circuitry be designed to integrate with the output devices. These are integration problems that neither the system taught in the '304 patent nor the '760 patent face because they utilize voice-activation after receiving a pre-processed and transmitted signal, whereas in a VOX system, the voice-activation is preformed first, then the signal is processed and/or converted for transmission.

The systems taught in the '304 patent and the '760 patent also don't deal with the problem of transmission delay because they are only directed at recording, not transmission. A VOX system is designed to transmit a detected human voice. Therefore, if the voice was recorded and then played back as disclosed in the '304 patent and the '760 patent, the individual speaking into the input device, typically a microphone, would hear his time-delayed voice making it very difficult for him to speak.

Another problem associated with VOX systems is power consumption and sparking. It is highly undesirable to have a portable system that has high power consumption as the portable power supply will be quickly exhausted and become correspondingly large and heavy. In addition, in certain applications, such as in classified hazardous locations or accidents zones, systems that generate any sparking cannot safely be utilized because of highly flammable substances that may be in the area.

Both the '304 patent and the '760 patent are non-portable systems and as such neither are concerned with providing very low power consumption to limit the size of a portable power supply and/or supply extended use between recharging. In addition, neither the '304 patent nor the '760 patent identify sparking as a problem or provide systems that effectively eliminate sparking for use in for instance, a hazardous location.

Still another problem facing VOX systems is ambient noise, especially in hostile acoustic environments such as, for instance, in a manufacturing facility or at an airport. In these extremely noisy conditions, it is difficult for VOX systems to operate properly. For example, it is undesirable for the VOX system to pickup and transmit ambient noise along with the human speech content.

Automatic Noise Reduction (“ANR”) technology has been in existence for a number of years, particularly in connection with protecting workers from very high ambient noise levels, such as on the tarmac at an airport. Currently, noise cancellation is primarily accomplished by means of mechanical, analog means involving the microphone elements and other parts of the microphone. These techniques however have had limited success.

In attempting to deal with cancellation of ambient noise, U.S. Pat. No. 5,046,103 to Warnaka et al. (“the '103 patent”) discloses a speech source that is exposed to ambient noise. To counter the ambient noise, a reference microphone is also exposed to the same ambient noise and both signals are fed into an acoustical signal controller to attenuate the noise component present in the voice signal. However, the '103 patent is not directed to VOX systems and is limited to the use with analog signals. Generally it is easier to manipulate digital signals than analog signals. In addition, analog circuitry typically requires more space which is undesirable in portable systems. Still further, the system taught in the '103 patent cannot be used in a hazardous location where sparking of the electronics may cause an explosion.

U.S. Pat. No. 6,483,923 to Marash (“the '923 patent”) discloses another system for reducing interference in a signal utilizing adaptive filters to generate canceling signals that approximate interference present in the received signal. The '923 patent further teaches converting the analog signals to a digital format. However, the '923 patent is not directed toward a VOX system for transmission but is adapted for use with an array of sensors utilized in connection with a recording system. (Col. 1, lines 17-20). A VOX system however, presents a different set of problems as compared to only recording systems as previously discussed. In addition, the large stationary sensor array disclosed in the '923 patent is not adapted for use with portable systems. In addition, the system taught in the '923 patent is not usable in hazardous locations because of sparking caused by the electronic circuitry.

U.S. Pat. No. 6,278,786 to McIntosh (“the '786 patent”) discloses still another noise cancellation system. The system is adapted for use with an earcup. A microphone is mounted in an earcup for transducing acoustic pressure within the earcup to a corresponding error signal which is converted into a noise cancellation signal. Again, the system taught in the '786 patent is not directed toward a VOX system and does not have to integrate with transmitting circuitry. In addition, the '786 patent fails to teach the use of voice activation to control a storage device or for processing of the received signals to generate a transmission signal. Still further, the '786 patent fails to teach a very low power consumption by the electronic circuitry, which is highly advantageous in portable systems. In addition, the '786 patent also fails to teach a system that reduces or effectively eliminates sparking such that it may be utilized in hazardous locations.

In view of the forgoing, a voice-activated transmission system is desired that limits or entirely eliminates any loss of speech to be transmitted.

It is further desired to provide a voice-activated transmission system that limits or effectively eliminates any time-delay associated with voice transmission.

It is still further desired to provide a voice-activated transmission system that limits or effectively eliminates ambient noise from the transmitted voice signal.

It is yet further desired to provide a portable voice-activated transmission system that limits loss of speech to be transmitted and limits ambient noise from the transmitted voice signal that is relatively light-weight and small in size.

It is still further desired to provide a voice-activated transmission system that uses very little power.

It is yet further desired to provide a portable voice-activated transmission system that may be safely used in a hazardous location where flammable vapors may be present in the area.

It is still further desired to provide a portable voice-activated transmission system that effectively eliminates any sparking.

### SUMMARY OF THE INVENTION

Accordingly, a VOX system has been provided integrating a store and forward integrated circuit. The storage function of the circuit would ensure that none of the speech picked up by the input device would be lost while the system determines if human speech is detected. In addition, the system utilized digital signal processing to provide superior noise cancellation. The use of digital circuitry for manipulation of the voice signal further reduces power consumption.

With the use of both an input device for receiving a voice input and a reference device for receiving a reference input corresponding to ambient noise. The VOX system can then utilize the reference input to cancel out ambient noise contained in the voice input. However, because both the voice input and the reference input are converted to digital signals, more effective noise cancellation is achieved as opposed to traditional analog systems. In addition, with the use of digital signal processing the lag time between voice identification and transmission is not discernable by the human ear, typically in the range of one nano-second.

The result is a VOX system that will effectively transmit all of the speech picked up by the input device without any discernable delay in transmission, while at the same time providing superior noise reduction characteristics in a light-weight, portable package.

The digital signal format the VOX system uses to manipulate the voice signal also reduces the power consumption of the system. This allows the power supply to be smaller and lighter weight and allows the system to operate for longer periods of time between recharging. The circuit design still further reduces or effectively eliminates sparking, which is necessary for use in hazardous locations.

The term “data” as used herein means any indicia, signals, marks, domains, symbols, symbol sets, representations, and any other physical form or forms representing information, whether permanent or temporary, whether visible, audible, acoustic, electric, magnetic, electromagnetic, or otherwise manifested. The term “data” as used to represent particular information in one physical form shall be deemed to encompass any and all representations of the same particular information in a different physical form or forms.

The term “storage” as used herein means data storage devices, apparatus, programs, circuits, systems, subsystems, or other elements whether implemented in hardware, software, or both, and whether used to process data in analog or digital form, into which data may be entered, and from which data may be obtained, as desired. Storage can be primary and/or secondary and can store data in electromagnetic, magnetic, optical, magneto-optical chemical and/or holographic forms.

The term “processor” as used herein means data processing devices, apparatus, programs, circuits, systems, and subsystems, whether implemented in hardware, software, or both, and whether used to process data in analog or digital form. The processor can operate on data in electromagnetic, magnetic, optical, magneto-optical chemical and/or holographic forms.

The terms “communicate”, “communicating” and “communications” as used herein include both conveying data from a source to a destination, as well as delivering data to a communications medium, system or link to be conveyed to a destination. The term “communication” as used herein means the act of communicating or the data communicated, as appropriate.

The terms “coupling”, “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, or (c) a functional relationship in which the operation of any one or more of the relevant devices, apparatus, files, programs, media, components, networks, systems, subsystems, or means depends, in whole or in part, on the operation of any one or more others thereof.

The term “network” as used herein means the communications linkage used to join two or more units, such as systems, networks, links, nodes, equipment, circuits, and devices and includes without limitation networks of all kinds, including coupling amongst components of a system, both intra-networks and inter-networks and including, but not limited to, the Internet, and is not limited to any particular such network.

The term “hazardous location” as used herein means any physical area within which any sparking or elevated temperature may cause an explosion or ignite a substance within that area that may be in the air such as, for instance but not limited to, any classified hazardous location (i.e. a refueling location, paint spray area, manufacturing facility, etc.), an accident location (i.e. fuel or flammable substance spill), or even a clean-up site.

In one advantageous embodiment a voice-activated transmission system is provided comprising, an audio input device for receiving an audio input, and a reference audio input device for receiving a reference audio input. The system further comprises a signal processor coupled to the audio input device and the reference audio input device, to store the audio input and the reference audio input when the audio input exceeds a threshold level, and to analyze the audio input for the presence of speech. The signal processor is further provided for generating an audio signal corresponding to the audio input and the reference audio input when speech is detected. The system still further comprises a transmitter coupled to the signal processor for transmitting the audio signal.

In another advantageous embodiment a voice-activated transmission system is provided comprising, an audio input device for receiving an audio input, and a reference audio input device for receiving a reference audio input. The system further comprises a signal analyzer coupled to the audio input device to determine if the audio input exceeds a threshold level and a storage device coupled to the audio input device and the reference audio input device to store the audio input and the reference audio input when the audio input exceeds a threshold level. The system still further comprises an activation device coupled to the storage device and for analyzing the audio input for the presence of speech, a signal processing device coupled to the activation device, for processing both the audio input and the reference audio input to generate an audio signal corresponding to both the audio input and the reference audio input when speech is detected by the activation device, and a transmitter coupled to the signal processing device for transmitting the audio signal.

In still another advantageous embodiment a method for voice-activated transmission is provided comprising the steps of, receiving an audio input, receiving a reference audio input, and determining whether the audio input exceeds a threshold level. The method further comprises the steps of, storing the audio input and the reference audio input when the audio input exceeds a threshold level, and determining whether the audio input comprises speech. The method still further comprises the steps of, processing the audio input and the reference audio input to generate an audio signal corresponding to both the audio input and the reference audio input, and transmitting the audio signal.

In yet another advantageous embodiment a method for voice-activated transmission is provided comprising the steps of, receiving an audio input, receiving a reference audio input, and storing the audio input and the reference audio input when the audio input exceeds a threshold level. The method further comprises the steps of, analyzing the audio input for the presence of speech, and converting the audio input and the reference audio input to digital signals when speech is detected. The method still further comprises the steps of, processing the audio input and the reference audio input to generate a audio signal corresponding to both the audio input and the reference audio input when speech is detected, and transmitting the audio signal to a transducer.

In still another advantageous embodiment a portable voice-activated audio transmission system is provided comprising, a first microphone for receiving an a first analog input signal representative of a voice input, and a second microphone for receiving a second analog input signal representative of an ambient noise input. The system further comprises a signal analyzer coupled to both the first and second microphones to analyze the first input signal for the presence of speech when an amplitude of the first input signal exceeds a threshold level. The system still further comprises a signal processor for converting both the first and second analog input signals to first and second digital signals respectively, and for processing the first and second digital signals to generate an output signal corresponding to both first and second digital signals, when speech is detected by the signal analyzer, and a transmitter coupled to the signal processor for transmitting the output signal.

The invention and its particular features and advantages will become more apparent from the following detailed description considered with reference to the accompanying drawings.

### BRIEF DESCRIPTION OF THE DRAWINGS

FIG. 1 is a block diagram illustrating an advantageous embodiment of the present invention.

FIG. 2 is a block diagram according to FIG. 1 illustrating the signal processor in greater detail.

FIG. 3 is a block diagram according to FIG. 2 illustrating the audio input conditioning device in greater detail.

FIG. 4 is a block diagram according to FIG. 2 illustrating the activation/storage device in greater detail.

FIG. 5 is a block diagram according to FIG. 2 illustrating the signal processing device in greater detail.

FIG. 6 is a flow diagram illustrating an advantageous embodiment of the present invention.

### DETAILED DESCRIPTION OF THE DRAWINGS

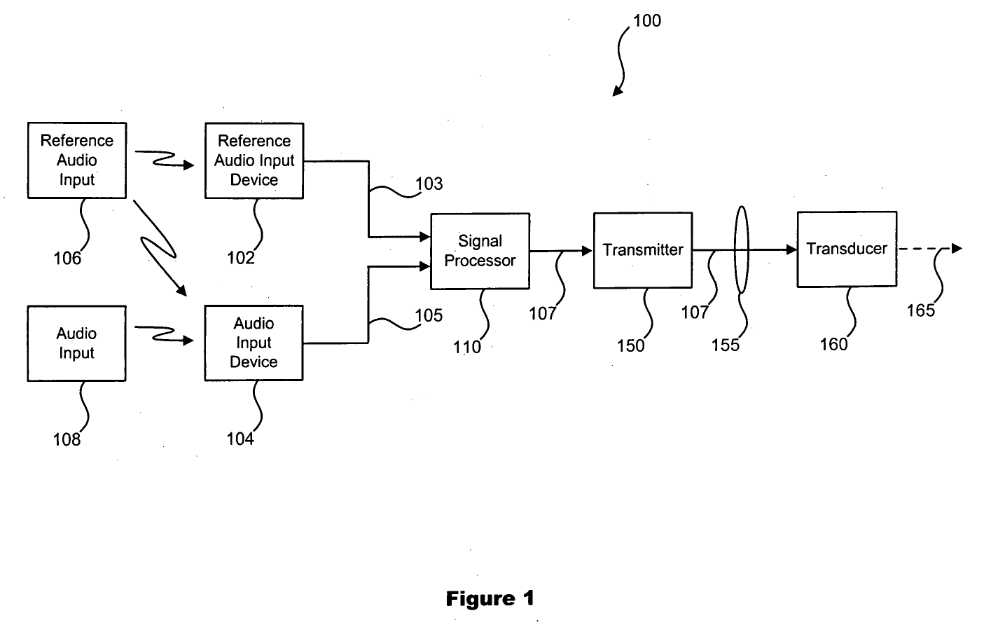

FIG. 1 illustrates one advantageous embodiment of VOX transmission system 100. As illustrated, VOX transmission system 100 includes reference audio input device 102 and audio input device 104, which may comprise for instance in one advantageous embodiment, microphones for picking up audio signals. Audio input device 104 is provided to pick up audio input 108, which may comprise speech. In addition, reference audio input device 102 is provided to pick up reference audio input 106, which may comprise ambient noise. In practice, audio input device 104 would advantageously be located near the source of audio input 108. If audio input device 104 is a microphone designed to pick up human speech, then the microphone would be located in close proximity to the user's mouth. Alternatively, reference audio input device 102 would be located apart from audio input device 104 so as not to pick up audio input 108. Rather, the purpose of reference audio input device 102 is to pick up ambient noise in the environment that may also be picked up by audio input device 104 in addition to audio input 108. Therefore, while audio input device 104 is advantageously picking up audio input 108, it is also disadvantageously picking up reference audio input 106 that comprise ambient noise. Alternatively, reference audio input device 102 is only picking up reference audio input 106. This is advantageous because in this manner, the audio input 108 can be distinguished from the reference audio input 106.

Ambient noise can be a major problem in harsh acoustical environments such as, manufacturing facilities, airport, construction sites, or any other environment where high levels of ambient noise are generated. These high ambient noise levels can interfere with the proper functioning of VOX equipment.

It is contemplated that both reference audio input device 102 and audio input device 104 may comprise any number of audio pick up devices, such as microphones. These audio pick up devices may be, for instance, hand-held units, boom-mounted units, or even mounted to a headset worn by a user. In addition, these audio pick up devices may be either hard wired and/or wireless systems. In one advantageous embodiment, both reference audio input device 102 and audio input device 104 comprise portable, miniature wireless microphones located in a headset worn by a user.

Reference audio input device 102 generates a reference audio input signal 103 which corresponds to reference audio input 106. Alternatively, audio input device 104 generates an audio input signal 105 that corresponds to a combination of both audio input 108 and reference audio input 106. Since reference audio input 106 corresponds to ambient noise in the environment, it is advantageous to remove this component from audio input signal 105.

Both reference audio input device 102 and audio input device 104 are coupled to signal processor 110 such that both reference audio input signal 103 and audio input signal 105 may be transmitted to signal processor 110. It is contemplated that reference audio input device 102 and audio input device 104 may be coupled to signal processor 110 by for instance, either a hardwired system and/or by wireless transmission. The data picked up by the input devices may be communicated by means of: electromagnetic energy, direct current (DC) energy, and the like.

Signal processor 110 monitors audio input signal 105 to determine if the signal strength is above a threshold level. If so, signal processor 110 will process both reference audio input signal 103 and audio input signal 105 to generate output signal 107. To generate output signal 107, signal processor 110 utilizes reference audio input signal 103 as a canceling signal to remove any like components from audio input signal 105. The result is that output signal 107 will only comprise the components of audio input 108, with all components of reference audio input 108 removed therefrom. This method provides superior noise cancellation for audio input 108 resulting in a signal free from ambient noise.

Output signal 107 is then sent to transmitter 150 which may comprise any suitable signal transmitter appropriate for the application. Transmitter 150 is coupled to transducer 160 via network connection 155. While FIG. 1 illustrates the use of network connection 155, it is contemplated that any connection means, local or networked may be utilized to transmit output signal 107 as desired. Network connection 155 may furthermore be or include for instance, but not limited to, any one or more of a WAP (Wireless Application Protocol) link, a GPRS (General Packet Radio Service) link, a GSM (Global System for Mobile Communication) link, or other wired or wireless, digital or analog interfaces or connections.

In addition, while output signal 107 is illustrated as being transmitted to transducer 160, it is still further contemplated that output signal may further be distributed as desired. For instance, rather than only terminating at transducer 160, output signal 107 may optionally be coupled to a dissemination link 165, which may be or include a Personal Area Network (PAN), a Family Area Network (FAN), a cable modem connection, an analog modem connection such as a V.90 or other protocol connection, an Integrated Service Digital Network (ISDN) or Digital Subscriber Line (DSL) connection, a BlueTooth wireless link, a WAP (Wireless Application Protocol) link, a Symbian™ link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, an IEEE 802.11-based radio frequency link, or other wired or wireless links.

It should be noted that VOX transmission system 100 is provided as an extremely low power consumption portable system. The circuit design of VOX transmission system 100 is further provided to suppress essentially any sparking or heating that may be generated by traditional electronic circuitry. As such VOX transmission system 100 does not require a large power supply and further may safely be utilized in hazardous locations. The effective elimination of sparking in VOX transmission system 100 is achieved in part by through use of spark-suppression techniques in the system. It should further be noted that the minimal power consumption of the portable equipment also has a tendency to reduce sparking of the system.

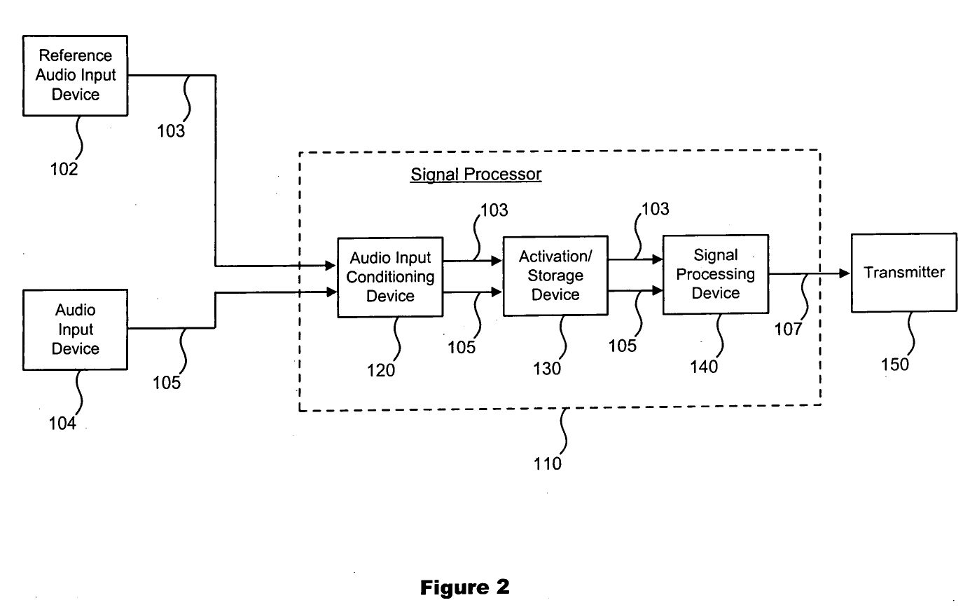

FIG. 2 is a block diagram according to FIG. 1 illustrating one advantageous embodiment of signal processor 110 in greater detail. Signal processor 110 is divided into three parts: audio input conditioning device 120, activation/storage device 130, and signal processing device 140.

Audio input conditioning device 120 is coupled to both audio input device 104 and reference audio input device 102 in a manner previously described in connection with FIG. 1. Audio input conditioning device 120 receives and measures audio input signal 105 to determine if it is above a threshold level. If audio input signal 105 is not above the threshold level, audio input conditioning device 120 will not forward audio input signal 105 or reference audio input signal 103 to activation/storage device 130. If however, audio input signal 105 is measured to be above the threshold level, audio input conditioning device 120 will forward both audio input signal 105 and reference audio input signal 103 to activation/storage device 130. In addition, in one advantageous embodiment, audio input conditioning device 120 will condition both audio input signal 105 and reference audio input signal 103 prior to forwarding them to activation/storage device 130.

Upon receipt, activation/storage device 130 begins storing received audio input signal 105 and reference audio input signal 103. Activation/storage device 130 further analyzes audio input signal 105 for the presence of speech components. If speech components are detected, activation/storage device 130 transmits both stored reference audio input signal 103 and audio input signal 105 to signal processing device 140 for processing. Signal processing device then processes both reference audio input signal 103 and audio input signal 105 to generate output signal 107 in a manner previously described in connection with FIG. 1. Output signal 107 may then be sent to transmitter 150 for transmission as desired.

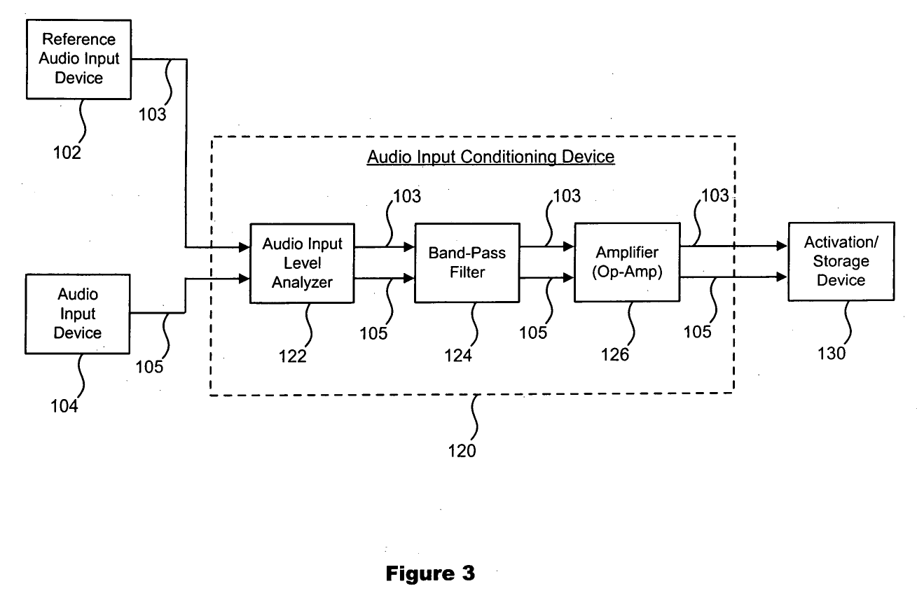

FIG. 3 is block diagram according to FIG. 2 illustrating one advantageous embodiment of audio input conditioning device 120 in greater detail. Audio input conditioning device 120 is generally divided into three parts: audio input level analyzer 122, band-pass filter 124, and amplifier 126.

Audio input level analyzer 122 is provided to analyze audio input signal 105 to determine if it exceeds a threshold level. In this manner, VOX transmission system 100 will not initiate a transmission sequence unless a minimum signal level is present at audio input device 104. Once a minimum signal level has been detected by audio input level analyzer 122, audio input signal 105 and reference audio input signal 103 are passed to band-pass filter 124. Band-pass filter 124 is typically selected to pass frequencies in the range in which human speech resides. Therefore, if audio input device 104 and reference audio input device 102 picking up robust ambient noise signals, any frequency component not within the range of human speech is removed. Any frequency components within the range of human speech are then transmitted to amplifier 126. Amplifier 126 is provided to increase the signal amplitude of audio input signal 105 and reference audio input signal 103 prior to them being sent to activation/storage device 150. Amplifier 126 may comprise any suitable amplifying device including, for instance but not limited to one or more, an operational amplifier(s) (op-amp), a transistor(s), a discrete circuit(s), an integrated circuit(s), a computer program(s), hardware, software, firmware, or any other selected means to amplify the signal amplitude to a desired level. Filtered and amplified audio input signal 105 and reference audio input signal 103 are then passed to activation/storage device 150.

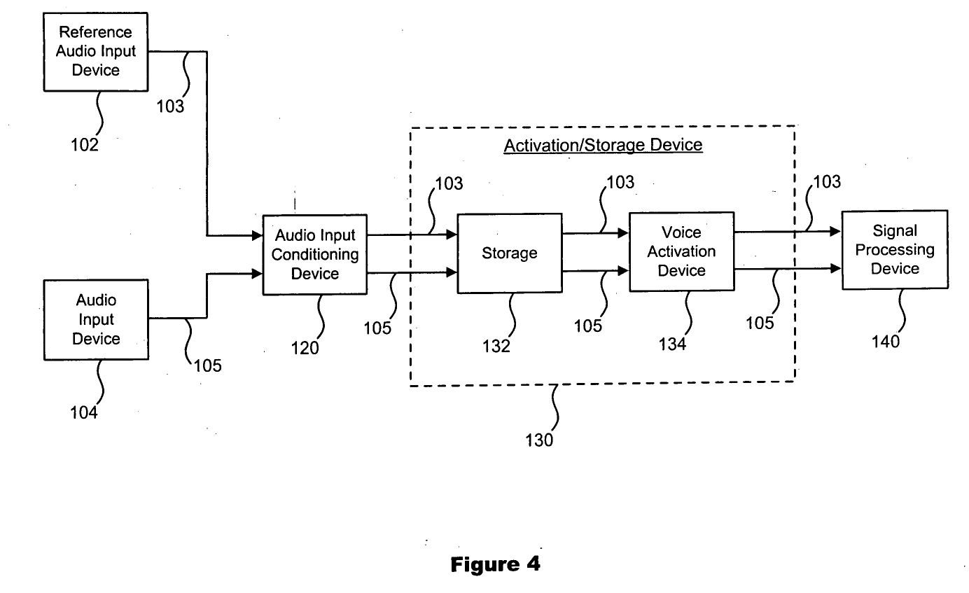

FIG. 4 is block diagram according to FIG. 2 illustrating one advantageous embodiment of activation/storage device 130 in greater detail. Activation/storage device 130 is generally divided into two parts: voice activation device 132, and storage 134.

Storage 132 is coupled to audio input conditioning device 120 to receive audio input signal 105 and reference audio input signal 103. Storage 132 is selected to operate such that upon receipt of audio input signal 105, storage 132 will begin storing both audio input signal 105 and reference audio input signal 103. Storage 132 will then forward audio input signal 105 and reference audio input signal 103 to voice activation device 134 for analysis.

Upon receipt of both audio input signal 105 and reference audio input signal 103, voice activation device 134 analyzes audio input signal 105 for the present of human speech. As previously mentioned, typically voice activation is achieved using circuitry design, such as is disclosed in U.S. Pat. No. 5,457,769 which is incorporated herein by reference. Once voice activation device 134 positively identifies the presence of human speech in audio input signal 105, both audio input signal 105 and reference audio input signal 103 are forwarded to signal processing device 140.

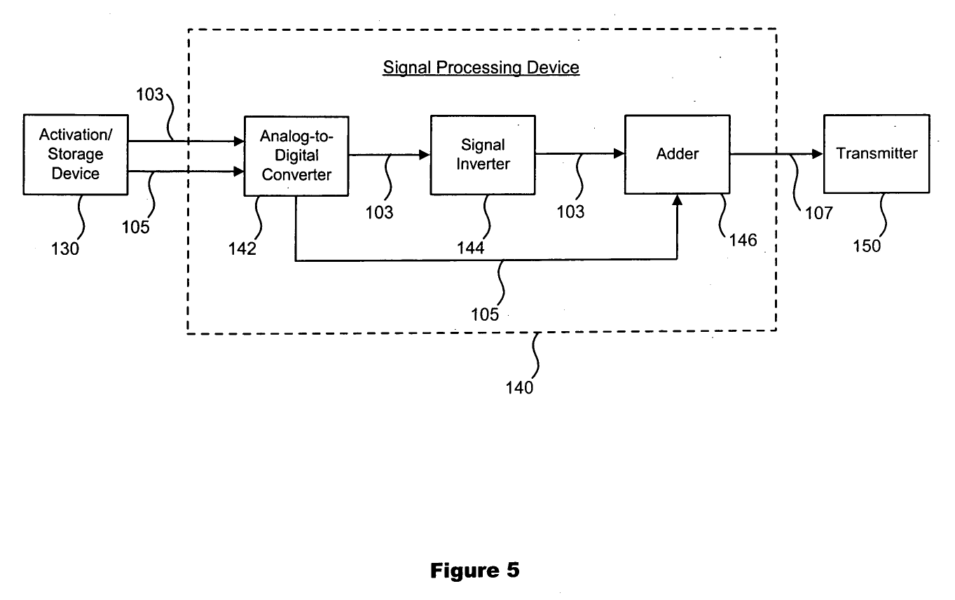

FIG. 5 is block diagram according to FIG. 2 illustrating one advantageous embodiment of signal processing device 140 in greater detail. Signal processing device 140 is generally divided into three parts: analog-to-digital converter 142, signal inverter 144, and adder 146.

Both audio input signal 105 and reference audio input signal 103 are received by analog-to-digital converter 142. Analog-to-digital converter 142 then converts both audio input signal 105 and reference audio input signal 103 from analog signals to digital signals. Reference audio input signal 103 is further sent to signal inverter 144 that inverts it and sends it to adder 146. Alternatively, audio input signal 105 is sent from analog-to-digital converter 142 to adder 146, bypassing inverter 144. Adder 146 combines both audio input signal 105 and inverted reference audio input signal 103 to generate output signal 107. This combination has the effect of canceling out the noise component still present in audio input signal 105 to provide superior noise cancellation. Output signal 107 is then sent to transmitter 150 for transmission as described in connection with FIG. 1.

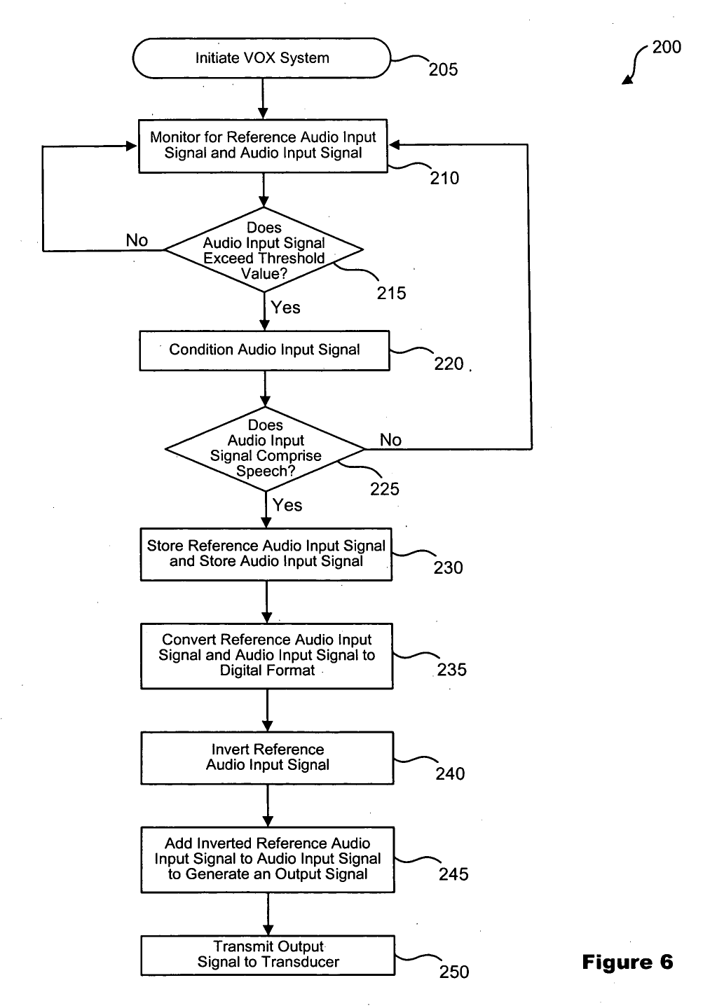

FIG. 6 is a flow chart illustrating the process steps of VOX transmission system 200 according to one advantageous embodiment. A first step is initiation of VOX system 205.

Once initiated, VOX transmission system 200 will monitor for reference audio input signal and audio input signal 210. The monitoring and receipt of both reference audio input signal 103 and audio input signal 105 may be completed as previously described in connection with FIG. 1. If an audio input signal 103 is received, the next step is to determine if audio input signal 105 exceeds a threshold value 215. Typically this threshold value is a measure of signal strength or signal amplitude. The threshold value may be any selected value appropriate for the application. If audio input signal 103 does not exceed the threshold value, VOX transmission system 200 returns to monitoring for reference audio input signal and audio input signal 210. If however, audio input signal 103 does exceed the threshold value VOX transmission system 200 proceeds to condition audio input signal and reference audio input signal 220. The signal conditioning preformed during this step may comprise all or any portion of the signal conditioning previously described in connection with FIGS. 2 and 3.

After audio input signal 103 and audio input signal 105 have been conditioned, VOX transmission system 200 proceeds to store reference audio input signal and audio input signal 225. This provides the distinct advantage of eliminating any potential loss of speech prior to VOX transmission system 200 transmitting an output signal as described in connection with FIGS. 2-4.

VOX transmission system 200 next determines if audio input signal comprises speech 230. There are a number of methods that may be utilized for voice recognition and as previously mentioned, typically voice activation is achieved using specific circuitry design, alternatively, computers utilizing software programs, hardware or firmware may effectively be utilized. If VOX transmission system 200 determines that audio input signal 105 does not comprise speech, VOX transmission system 200 returns to monitoring for reference audio input signal and audio input signal 210. If however, VOX transmission system 200 determines that audio input signal 103 does comprise speech, VOX transmission system 200 proceeds to convert reference audio input signal and audio input signal to digital signals 235.

VOX transmission system 200 further proceeds to invert reference audio input signal 240 and then add inverted reference audio input signal to audio input signal to generate an output signal 245. As these steps have already been described in connection with FIGS. 2 and 5, they will not be re-described here. Finally, VOX transmission system 200 proceeds to transmit output signal to transducer 250.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

It should further be noted that VOX transmission system 200 is provided as a fully portable system with very low power consumption thereby requiring a small and lightweight power source. VOX transmission system 200 is further designed such that effectively no sparking is generated and as such is safe to utilize in a hazardous location.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A portable voice-activated transmission system comprising:
a first audio input device for receiving a first audio input;
a second audio input device for receiving a second audio input;
a signal processor coupled to said first and said second audio input devices, to receive and store the first and second audio inputs when the first audio input exceeds a threshold level, and to analyze the first audio input for the presence of a voice component, said signal processor generating an output signal corresponding to the first and second audio inputs when the voice component is detected; and
a transmitter coupled to said signal processor for transmitting the output signal.

2. The portable voice-activated transmission system according to claim 1 further comprising an analog-to-digital converter to convert the first and second audio inputs to digital signals.

3. The portable voice-activated transmission system according to claim 1 further comprising a band-pass filter to filter the first audio input.

4. The portable voice-activated transmission system according to claim 1 further comprising an amplifier for amplifying the first audio input.

5. The portable voice-activated transmission system according to claim 4 wherein said amplifier comprises an op-amp.

6. The portable voice-activated transmission system according to claim 1 wherein said first audio input device comprises a microphone.

7. The portable voice-activated transmission system according to claim 1 wherein said second audio input device comprises a microphone.

8. The portable voice-activated transmission system according to claim 1 wherein said signal processor inverts the second audio input and adds the inverted second audio input to the first audio input to generate the output signal.

9. The portable voice-activated transmission system according to claim 1 further comprising a transducer coupled to said transmitter for receiving the output signal.

10. The portable voice-activated transmission system according to claim 9 wherein said transducer comprises a speaker.

11. A portable voice-activated transmission system for use in a hazardous location comprising:
an audio input device for receiving an audio input;
a reference audio input device for receiving a reference audio input;
a signal analyzer coupled to said audio input device to determine if the audio input exceeds a threshold level and for determining if the audio input comprises a voice component;
a memory storage coupled to said audio input device and said reference audio input device to store the audio input and the reference audio input when it is determined that the audio input exceeds the threshold level;
a signal processor coupled to said signal analyzer, for processing both the audio input and the reference audio input to generate an output signal corresponding to both the audio input and the reference audio input when the voice component is detected; and
a transmitter coupled to said signal processor for transmitting the output signal.

12. The portable voice-activated transmission system according to claim 11 further comprising an analog-to-digital converter for converting the audio input and the reference audio input to digital signals.

13. The portable voice-activated transmission system according to claim 11 further comprising a band-pass filter to filter the audio input.

14. The portable voice-activated transmission system according to claim 11 further comprising an amplifier for amplifying the audio input.

15. The portable voice-activated transmission system according to claim 14 wherein said amplifier comprises an op-amp.

16. The portable voice-activated transmission system according to claim 11 wherein said audio input device comprises a microphone.

17. The portable voice-activated transmission system according to claim 11 wherein said reference audio input device comprises a microphone.

18. The portable voice-activated transmission system according to claim 11 further comprising:
an signal inverter for inverting the reference audio input; and
an adder for adding the inverted reference audio input to the audio input to generate the output signal.

19. The portable voice-activated transmission system according to claim 11 further comprising a transducer coupled to said transmitter for receiving the output signal.

20. The portable voice-activated transmission system according to claim 19 wherein said transducer comprises a speaker.

21. A method for portable voice-activated transmission for use in a hazardous location comprising the steps of:
receiving an audio input;
generating an audio input signal;
receiving a reference audio input;
generating a reference audio input signal;
determining whether the audio input signal exceeds a threshold level;
storing the audio input signal and the reference audio input signal when the audio input signal exceeds the threshold level;
determining whether the audio input signal comprises a voice component;
processing the audio input signal and the reference audio input signal to generate an output signal when the voice component is detected, the output signal corresponding to both the audio input signal and the reference audio input signal;
transmitting the output signal; and
suppressing any sparking that may be generated by the method.

22. The method for portable voice-activated transmission according to claim 21 further comprising the step of converting the audio input and the reference audio input to digital signals.

23. The method for portable voice-activated transmission according to claim 21 further comprising the step of filtering the audio input signal.

24. The method for portable voice-activated transmission according to claim 21 further comprising the step of amplifying the audio input signal.

25. The method for portable voice-activated transmission according to claim 21 further comprising the steps of inverting the reference audio input signal and adding the inverted reference audio input signal to the audio input signal to generate the output signal.

26. A method for portable voice-activated transmission comprising the steps of:
receiving an audio input;
receiving a reference audio input;
analyzing the audio input for the presence of a voice component;
converting the audio input and the reference audio input to digital signals;
processing the audio input and the reference audio input to generate a digital output signal when the voice component is detected, the digital output signal corresponding to both the audio input and the reference audio input; and
transmitting the output signal.

27. The method for portable voice-activated transmission according to claim 26 further comprising the step of filtering the audio input.

26. The method for portable voice-activated transmission according to claim 26 further comprising the step of amplifying the audio input.

27. The method for portable voice-activated transmission according to claim 26 further comprising the steps of inverting the reference audio input digital signal and adding the inverted reference audio input digital signal to the audio input digital signal to generate the digital output signal.

28. The method for portable voice-activated transmission according to claim 26 further comprising the step of storing the audio input and the reference audio input when the audio input exceeds a threshold level.

29. A portable voice-activated audio transmission system comprising:
a first microphone for receiving an a first analog input signal representative of a voice component input;
a second microphone for receiving a second analog input signal representative of an ambient noise component input;
a signal analyzer coupled to both said first and second microphones to analyze the first analog input signal for the presence of a voice component when an amplitude of the first analog input signal exceeds a threshold level,
a signal processor for converting both the first and second analog input signals to first and second digital input signals respectively, and for processing the first and second digital input signals to generate a digital output signal corresponding to both first and second digital input signals, when the voice component is detected; and
a transmitter coupled to said signal processor for transmitting the digital output signal.

30. The portable voice-activated transmission system according to claim 29 further comprising a memory storage coupled to said signal analyzer to store the first and second analog input signals.

31. A portable voice-activated transmission system for use in a hazardous location comprising:
a first audio input device for receiving a first audio input and for generating a first audio input signal corresponding to the first audio input;
a second audio input device for receiving a second audio input and for generating a second audio input signal corresponding to the second audio input;
a signal processing device to store the first and second audio input signals and for generating a digital audio output signal representative of the first and second audio input signals when it is determined that the first audio input signal is above a threshold level and comprises a voice component; and
a transmission device coupled to said signal processing device for transmitting the digital audio output signal.
